(19) United States
(12) Patent Application Publication
(10) Pub. No.: US 2019/0224785 A1
(43) Pub. Date: Jul. 25, 2019

(54) CLAMPING ELEMENT FOR A CLAMPING DEVICE FOR WELDING WORKPIECES, AND CLAMPING DEVICE

(71) Applicant: ADIENT LUXEMBOURG HOLDING S.À R.L., Luxembourg (LU)

(72) Inventors: Udo EBERLE, Kaiserslautern (DE); Lars KRAMM, Trippstadt (DE); Marcus BAUMGAERTNER, Rockenhausen (DE); Claus PETERSMANN, Gaugrehweiler (DE)

(21) Appl. No.: 16/337,535

(22) PCT Filed: Sep. 22, 2017
(86) PCT No.: PCT/EP2017/074129

§ 371 Date: Mar. 28, 2019

(30) Foreign Application Priority Data
Sep. 29, 2016 (DE) 10 2016 218 869.0
Dec. 21, 2016 (DE) 10 2016 225 831.1

(51) Int. Cl. B23K 37/04; B23K 9/007

(52) U.S. Cl. CPC B23K 37/0435; B23K 2101/006; B23K 9/007; B23K 37/0408

(57) ABSTRACT

A clamping element (100) is provided for a clamping device (200) for welding workpieces (10). The clamping element (100) includes a housing (110) and a pressure piece (120) that is arranged in a movable manner relative to the housing (110). The pressure piece (120) is supported at least indirectly on the housing (110) by a spring (130). The spring (130) is arranged in a radial direction between the housing (110) and a sleeve (150). A gas nozzle (300), of a welding device, is introducable into the housing (110), in particular into the sleeve (150). A clamping device (200) is also provided for welding workpieces (10). The clamping device (200) has at least one clamping element (100).

### CROSS REFERENCE TO RELATED APPLICATIONS

This application is a U.S. National Phase Application of International Application PCT/EP2017/074129, filed Sep. 22, 2017, and claims the benefit of priority under 35U.S.C. § 119 of German Applications 10 2016 218 869.0, filed Sep. 29, 2016 and 10 2016 225 831.1, filed Dec. 21, 2016, the entire contents of which are incorporated herein by reference.

### TECHNICAL FIELD

The invention relates to a clamping element for a clamping device for welding workpieces, the clamping element having a housing and a pressure piece which is arranged so as to be movable relative to the housing, wherein the pressure piece is supported at least indirectly on the housing by means of a spring. The invention additionally relates to a clamping device.

### TECHNICAL BACKGROUND

DE 10 2006 014 068 A1 discloses a device for clamping components during welding of metal sheet components arranged in two or more layers, having a holder for a machining head, in particular for a laser machining head, which holder can be fitted onto an industrial robot in order to guide the machining head along a machining line, having a pressure-exerting element which is mounted on the holder so as to be movable relative thereto, and having a pressure-exerting device provided operatively between holder and pressure-exerting element. The pressure-exerting element is arranged laterally next to a welding point to be produced.

DE 10 2009 024 758 A1 discloses a device for use with a welding device, the device having a housing component; a movable component which is at least partially arranged in the housing component and has a contact surface for contacting a workpiece; and a biasing component which is at least partially arranged in the housing component, wherein the welding device is moved forward in the direction of the workpiece during an operation, with the result that the contact surface contacts the workpiece and forces the movable component into the housing component counter to the force of the biasing component.

DE 10 2009 053 261 A1 discloses a device for spot welding by means of laser beam, comprising at least one welding unit with an optical axis along which there are arranged a high-power diode laser, a beam-forming optics and a tube, and also a component receptacle in which the components to be welded are positioned with respect to the welding unit, and means for producing a pressing force between the free tube end facing away from the beam-forming optics and the components to be welded in the direction of the optical axis. It is possible for a plurality of welding points to be produced simultaneously by means of a plurality of welding units.

DE 28 09 297 C3 discloses an electric spot welding gun, comprising two mutually opposite electrodes, in which one electrode has a surface which contacts the workpiece and which is of approximately the same size as the welding point, wherein the other electrode is carried by an arm to which there is connected a contact member which conducts the welding current and which can be moved towards a surface of the other electrode to bear thereon.

### SUMMARY

An object on which the invention is based is to make available a clamping element and a clamping device for producing optimized welded connections. In particular, the clamping element is intended to make it possible, by means of MAG through-welding points, to allow a connection of components of a vehicle seat, in particular of a seat frame with a large-area rear wall structure of small metal sheet thickness, under the aspect of one-sided torch accessibility and limited shielding gas charging. In particular, the clamping element is intended to be insensitive to welding spatter. In particular, a clamping device is intended to allow the production of a plurality of welding points in succession with precisely only one gas nozzle.

This object is achieved according to the invention by a clamping element for a clamping device for welding workpieces, the clamping element having a housing and a pressure piece which is arranged so as to be movable relative to the housing, wherein the pressure piece is supported at least indirectly on the housing by means of a spring, and the spring is arranged in the radial direction between the housing and a sleeve, and a gas nozzle of a welding device can be introduced into the housing, in particular into the sleeve.

By virtue of the fact that the spring is arranged in the radial direction between the housing and a sleeve, the clamping element is insensitive to welding spatter. By virtue of the fact that a gas nozzle of a welding device can be introduced into the housing of the clamping element, the clamping element can clamp the workpieces to be joined against one another while extending around the welding point to be produced. It is possible, by comparison with the prior art, to produce welding points whose quality and strength are increased.

The pressure piece is preferably annular. In an annular pressure piece, a gas nozzle can be introduced and/or guided into the pressure piece. The pressure piece can be circular ring-shaped. The pressure piece can be rotationally symmetrical.

The clamping elements can be particularly advantageously used in clamping devices for clamping at least two workpieces which are to be connected to one another by means of metal active gas welding (MAG welding). One-sided through-welding can occur here. MAG welding is a form of shielding gas welding, in particular for steel, that is known per se. An electric arc burns between a current-carrying wire electrode and a workpiece under shielding gas. A machine-fed wire serves as electrode and melts in the electric arc.

The gas nozzle can be able to be at least partially introduced into the sleeve. The gas nozzle can be able to be at least partially introduced into the pressure piece. The gas nozzle can be able to be introduced centrally into the sleeve. The gas nozzle can be able to be introduced centrally into the pressure piece. As a result, welding points can be produced centrally to a bearing surface of the pressure piece on an upper one of the workpieces to be clamped and to be joined. A welding wire can advantageously be guided through the pressure piece, with the result that the welding wire comes substantially perpendicularly into contact with the upper one of the workpieces to be clamped. The welding wire can preferably be guided centrally through the pressure piece.

The pressure piece is supported at least indirectly on the housing by means of a spring. The spring can be a helical compression spring. The spring can bias the pressure piece. The spring can bias the pressure piece in the direction of a longitudinal axis. The longitudinal axis can be oriented substantially perpendicularly to the surfaces of the workpieces to be joined. The pressure piece is preferably displaceable relative to the housing along the longitudinal axis. The spring is tensioned by the displacement of the pressure piece into the housing.

The pressure piece can preferably be tiltable with respect to the longitudinal axis, that is to say an angle can result between a longitudinal axis of the pressure piece and the longitudinal axis of the housing. This can be achieved by the pressure piece being mounted with play relative to the housing. The possibility of tilting ensures that the pressure piece can bear flat on the upper one of the workpieces to be clamped.

The sleeve is preferably connected to the pressure piece. The pressure piece is particularly preferably screwed to the sleeve. The spring is protected from welding spatter by means of the sleeve. Without the sleeve, welding spatter would adhere to the spring, in particular between the windings of the spring, and thus disadvantageously influence the function of the spring.

The pressure piece can have at least one hole for the outflow of gas. The at least one hole for the outflow of gas can be arranged in a peripheral wall of the pressure piece, with the result that gas can escape laterally from the pressure piece. A hole can be, for example, a bore or a groove or some other opening. A plurality of holes are preferably arranged in a distributed manner over the circumference of the pressure piece, in particular uniformly. The pressure piece preferably consists of a material to which welding spatter does not adhere, in particular tungsten copper.

The object is additionally achieved by a clamping device for welding workpieces, wherein the clamping device has at least one clamping element according to the invention. Precisely one clamping element is advantageously provided for each of the welding points to be produced. The arrangement of the clamping elements in the clamping device can be a run-around arrangement. The arrangement of the clamping elements in the clamping device can be equidistant. The arrangement of the clamping elements in the clamping device can be distributed nonuniformly.

The clamping device can have a clamping element receptacle for receiving a plurality of clamping elements. The clamping elements can each be arranged in the region of a welding point to be produced. The clamping element receptacle can be plate-shaped. The clamping element receptacle can be a metal sheet with a high metal sheet thickness. The clamping element receptacle can at the same time be a tool carrier. The clamping element receptacle can have a perforated pattern, wherein a clamping element is arranged, in particular inserted and screwed, in the region of each hole. For this purpose, the housing can have an external thread and a counterpart can have an internal thread, with the result that the counterpart can be screwed onto the housing. By screwing the counterpart onto the housing it is possible for an edge of the clamping element receptacle that extends around a hole of the clamping element receptacle to be clamped in between housing and pressure piece.

The object is additionally achieved by a clamping device for welding workpieces, in which the clamping element has a housing and a pressure piece which is arranged so as to be movable relative to the housing, wherein a gas nozzle of a welding device can be introduced into the housing. The clamping device can have a clamping element receptacle for receiving a plurality of clamping elements, wherein each clamping element is arranged in the region of a welding point to be produced and precisely one gas nozzle can be introduced temporally in succession into individual ones of the clamping elements for producing a respective welding point.

In summary, and expressed in other words, an optimized mechanical clamping device for producing metal active gas (MAG) welded connections by means of MAG through-welding points can be made available by means of the clamping elements according to the invention. The clamping device ensures the low-gap positioning of the components to be joined in the joining region with the simultaneous possibility of compensating for flatness deviations and ensuring outgassing of the shielding gas. The MAG torch, including flanged-on shielding-gas nozzle, can engage in the clamping element. By virtue of a plurality of clamping elements in a clamping device, there arises a surface pressure which is virtually uniformly distributed, but locally limited around the clamping elements, wherein a spring biasing and a spring travel can be adapted to the welding task. A clamping element according to the invention preferably has an outgassing aid which is produced from tungsten copper in order to minimize the adhesion of welding spatter. The clamping elements make possible the construction of a clamping device for producing welded connections by means of MAG through-welding points in particular for connecting a seat frame having a large-area rear wall structure of low metal sheet thickness under the aspect of one-sided torch accessibility and limited shielding gas charging.

The invention will be explained in more detail below with reference to an advantageous exemplary embodiment illustrated in the figures. However, the invention is not limited to this exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a sectional view through a clamping element according to the invention, wherein the clamping element is mounted in a clamping device and clamps a workpiece;

FIG. 2 is a detail illustration of the workpiece according to the detail II in FIG. 1;

FIG. 3 is an exploded illustration of the clamping element from FIG. 1;

FIG. 4 is a sectional view corresponding to FIG. 1, wherein a gas nozzle is introduced into the clamping element;

FIG. 5 is a sectional view through the clamping element according to the invention, wherein a pressure piece of the clamping element is positioned at an inclination with respect to a housing of the clamping element;

FIG. 6 is an exploded illustration of a clamping device according to the invention; and

FIG. 7 is a perspective illustration of the clamping device from FIG. 6.

### DESCRIPTION OF PREFERRED EMBODIMENTS

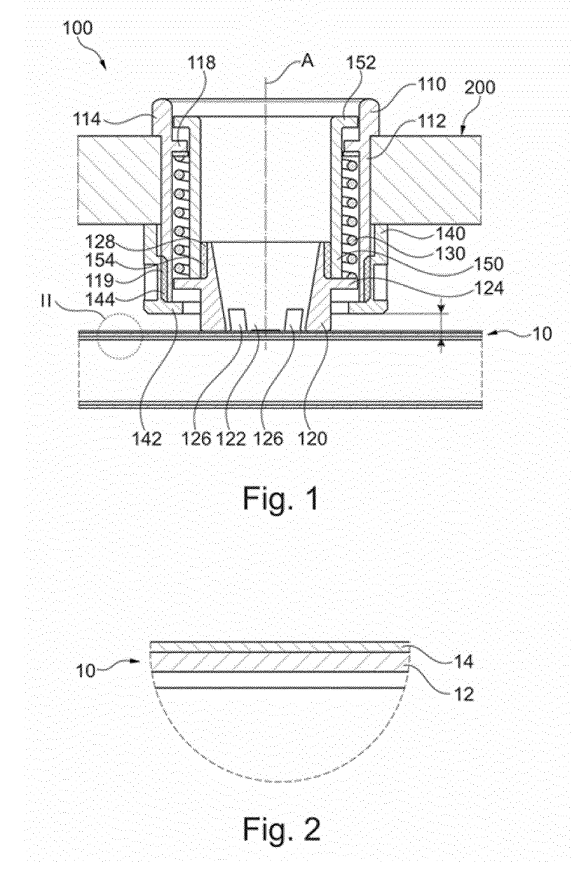

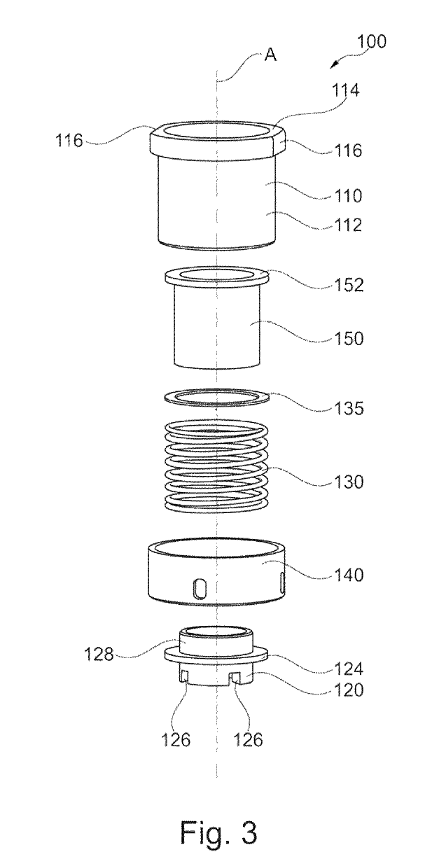

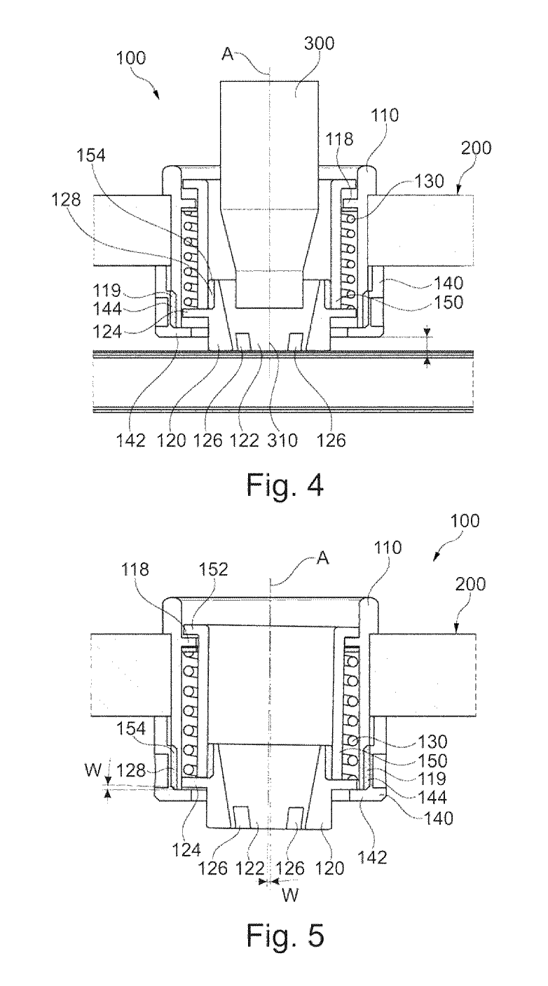

Referring to the drawings, FIG. 1 shows a section through a clamping element 100 according to the invention, wherein the clamping element 100 is mounted in a clamping device 200, which is illustrated only in part, and clamps a workpiece 10.

FIG. 2 shows a detail illustration of the section through the workpiece 10. The workpiece 10 comprises a hollow profile 12 and a substantially planar metal sheet 14 which is to be connected to the hollow profile 12 by means of at least one MAG welding point, preferably a plurality of MAG welding points. The wall thickness of the hollow profile 12 is greater than the metal sheet thickness of the metal sheet 14. The metal sheet thickness of the metal sheet 14 is preferably less than 1 mm, most preferably less than 0.6 mm. By means of the clamping element 100, the metal sheet 14 is clamped with a force onto the hollow profile 12, with the result that a gap between the hollow profile 12 and the metal sheet 14 is avoided.

In the present case, the clamping element 100 has a substantially rotationally symmetrical structure. A longitudinal axis A defines an axis of rotation and extends, in a basic position of the clamping element 100, parallel to a force direction of a force which can be produced by the clamping element 100 and which can be introduced onto an annular surface of the metal sheet 14. The longitudinal axis A defines the directional indications of a cylinder coordinate system that are used below. In particular, a longitudinal direction, a radial direction and a circumferential direction are defined by the longitudinal axis A.

The clamping element 100 has a housing 110 and a pressure piece 120 which is guided so as to be movable to a limited degree relative to the housing 110. The pressure piece 120 is biased by means of a spring 130, in the present case a compression spring. In the present case, the clamping element 100 additionally has a counterpart 140 for fastening the housing 110 to the clamping device 200, and a sleeve 150.

The housing 110 has a substantially circular cylindrical basic body 112. A center axis of the basic body 112 corresponds to the longitudinal axis A. At one end of the basic body 112, the latter has a collar 114 whose outside diameter is greater than the outside diameter of the remainder of the basic body 112. The collar 114 has two parallel surfaces 116 formed thereon in such a way that, during the mounting of the clamping element 100 on the clamping device 200, the collar 114 can be turned or fixed by means of a tool, in particular a wrench. Projecting radially inward from the substantially cylindrical inner surface of the basic body 112 is an annular supporting means 118 for supporting the spring 130, said supporting means in the present case being formed in one piece with the basic body 112 of the housing 110, in particular in the form of a collar. In an end region facing away from the collar 114, the housing 110 has an external thread 119.

The pressure piece 120 has a substantially rotationally symmetrical configuration. The pressure piece 120 has a conical opening 122 on the inside. An outer wall of the pressure piece 120 is doubly stepped in the longitudinal direction, that is to say that the outer wall is composed of three circular cylindrical portions of different diameter. A central circular cylindrical portion as viewed in the longitudinal direction has the largest outside diameter of the three circular cylindrical portions, wherein the central circular cylindrical portion forms a supporting collar 124 for the spring 130 and the sleeve 150. The wall of the pressure piece 120 has, on the periphery, a plurality of holes 126 which guide the opening 122 in the radial direction through the outer wall of the pressure piece 120. The holes 126 serve for degassing the clamping element 100 during a welding operation. An end of the pressure piece 120 that faces the sleeve 150 has an external thread 128.

The pressure piece 120 is produced from a material to which welding spatter does not adhere, in the present case from a tungsten copper.

The sleeve 150 has a substantially hollow-cylindrical geometry with an L-shaped wall cross section. The sleeve 150 has a radially outwardly pointing collar 152. The sleeve 150 has an internal thread 154. The pressure piece 120 is screwed to the sleeve 150. For this purpose, the internal thread 154 interacts with the external thread 128.

The counterpart 140 has a substantially hollow-cylindrical geometry with an L-shaped wall cross section. The counterpart 140 has a radially inwardly pointing collar 142. The counterpart 140 has an internal thread 144. The counterpart 140 is screwed by means of the internal thread 144 to the external thread 119 of the housing 110. In a mounted state in the clamping device 200, the housing 110 inserted into a mounting bore of the clamping device 200 is secured by means of the counterpart 140. Here, the counterpart 140 acts as a screw nut, in particular as a clamping nut.

The housing 110 and the counterpart 140 together form an installation space within which the spring 130, the sleeve 150 and in part also the pressure piece 120 are arranged, and from which the pressure piece 120 projects at least in certain portions.

The spring 130 is arranged and biased in the longitudinal direction A between the supporting means 118 of the housing 110 and the supporting collar 124 of the pressure piece 120. In the radial direction, the spring 130 is arranged between the housing 110 and the sleeve 150. Here, the sleeve 150 is arranged in the housing 110 in such a way that the collar 152 of the sleeve 150 can be supported on the supporting means 118 of the housing 110 on that side of the supporting means 118 facing away from the spring 130. In the present case, a disk 135 for more uniform force distribution is arranged between the spring 130 and the supporting means 118. However, this disk 135 is not absolutely necessary.

By virtue of the above-described structure, a gas nozzle 300 of an MAG welding device can be introduced into the clamping element 100. A welding wire 310 emerging from the gas nozzle 300 can be guided onto the surface of the workpiece 10. Gases which occur during welding can escape from the pressure piece 120 through the holes 126. The sleeve 150 covers the spring 130 against welding spatter.

By virtue of the above-described structure of the clamping element 100, the pressure piece 120 can be inserted into the housing 110 under further biasing of the spring 130. Here, the guidance of the pressure piece 120 and of the sleeve 150 connected to the pressure piece 120 in the housing 110 has so much play that an inclined position of the pressure piece 120 relative to the housing 110 can occur. In FIG. 5, this inclined position is indicated by an angle W. The inclined position through the angle W allows the pressure piece 120 to bear flat on the workpiece 10 even when, on account of tolerances, the workpiece 10 is not arranged exactly perpendicular to the longitudinal axis A.

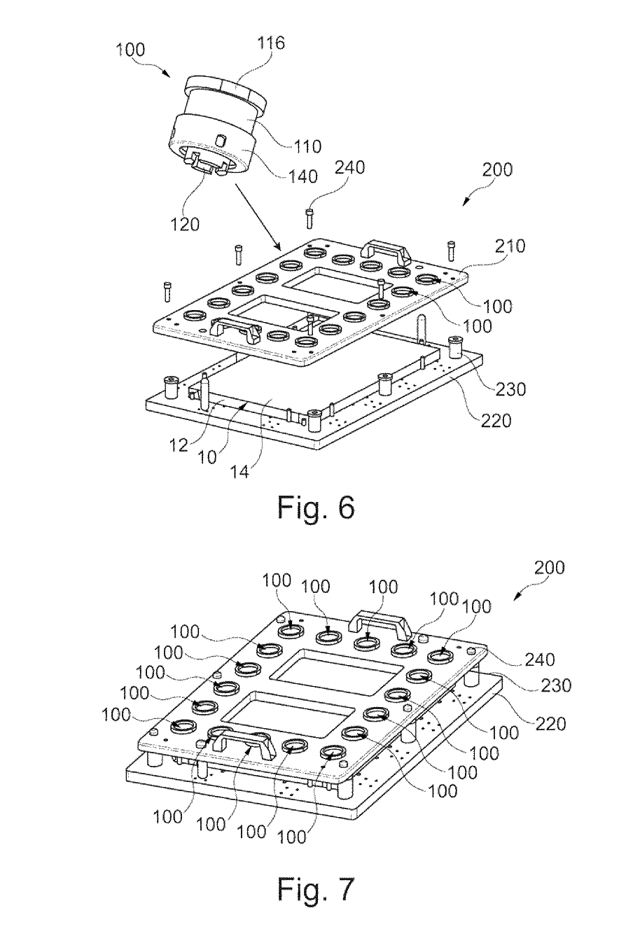

FIGS. 6 and 7 show, by way of example and in simplified fashion, a clamping device 200 in which a plurality of the clamping elements 100 according to the invention are installed. The clamping device 200 has a plate-shaped clamping element receptacle 210 and a base plate 220 which are spaced apart from one another by means of a plurality of spacer sleeves 230. The clamping element receptacle 210 is screwed to the base plate 220 by means of a plurality of screws 240. The workpiece 10 to be welded, that is to say the hollow profile 12 and the metal sheet 14, is arranged between the clamping element receptacle 210 and the base plate 220. The metal sheet 14 is clamped onto the hollow profile 12 by means of the clamping elements 100. In the present case, the metal sheet 14 and the hollow profile 12 are components of a backrest of a vehicle seat.

The clamping device 200 has a plurality of the clamping elements 100 according to the invention. The workpiece 10 to be welded is preferably welded with precisely one gas nozzle 300, wherein the precisely one gas nozzle 300 is introduced in succession into the individual clamping elements 100 of the clamping device 200 and a welding point is produced. Thus, only one gas nozzle 300 is required. The workpiece 10 to be welded is clamped by the clamping device 200 independently of the gas nozzle 300. The workpiece 10 to be welded is clamped by a plurality of clamping elements 100 independently of the gas nozzle 300.

The features disclosed in the above description, the claims and the drawings may be of importance both individually and in combination for realizing the invention in its various configurations.

Although the invention has been described in detail in the drawings and the account given above, the accounts should be understood as being illustrative and by way of example and nonlimiting. In particular, the selection of the proportions illustrated for the individual elements in the drawings should not be interpreted as being necessary or limiting. Furthermore, the invention is, in particular, not limited to the exemplary embodiments explained. Further variants of the invention and the implementation thereof can be gathered by a person skilled in the art from the above disclosure, the figures and the claims.

Terms such as “comprise”, “have”, “include”, “contain” and the like used in the claims do not rule out other elements or steps. The use of the indefinite article does not rule out a plurality. An individual device can perform the functions of a plurality of devices or units mentioned in the claims.

While specific embodiments of the invention have been shown and described in detail to illustrate the application of the principles of the invention, it will be understood that the invention may be embodied otherwise without departing from such principles.

1. A clamping element for a clamping device for welding workpieces, the clamping element comprising:
a housing;
a pressure piece arranged so as to be movable relative to the housing;
a spring, wherein the pressure piece is supported at least indirectly on the housing by means of the spring; and
a sleeve, wherein the spring is arranged in a radial direction between the housing and the sleeve, and a gas nozzle of a welding device can be introduced into the housing and into the sleeve.

2. The clamping element as claimed in claim 1, wherein the pressure piece is annular.

3. The clamping element as claimed in claim 1, wherein the gas nozzle can be at least partially introduced into the pressure piece.

4. The clamping element as claimed in claim 1, wherein a welding wire can be guided through the pressure piece.

5. The clamping element as claimed in claim 1, wherein the spring biases the pressure piece, in particular in the direction of a longitudinal axis.

6. The clamping element as claimed in claim 1, wherein the pressure piece is displaceable relative to the housing along a longitudinal axis.

7. The clamping element as claimed in claim 6, wherein the pressure piece is tiltable with respect to the longitudinal axis.

8. The clamping element s claimed in claim 6 wherein the pressure piece is tiltable with respect to the housing.

9. The clamping element as claimed in claim 1, wherein the pressure piece has at least one hole for the outflow of gas.

10. The clamping element as claimed in claim 1, wherein the sleeve is connected to the pressure piece.

11. The clamping element as claimed in claim 1, wherein the pressure piece is screwed to the sleeve.

12. The clamping element as claimed in claim 1, wherein the spring is protected from welding spatter by means of the sleeve.

13. A clamping device for welding workpieces, the clamping device comprising at least one clamping element and the at least one clamping element comprises:
a housing;
a pressure piece arranged so as to be movable relative to the housing;
a spring, wherein the pressure piece is supported at least indirectly on the housing by means of the spring;
a sleeve, wherein the spring is arranged in a radial direction between the housing and the sleeve, and a gas nozzle of a welding device can be introduced into the housing and into the sleeve.

14. A clamping device for welding workpieces, wherein the clamping element has a housing and a pressure piece which is arranged so as to be movable relative to the housing, wherein a gas nozzle of a welding device can be introduced into the housing.

15. The clamping device as claimed in claim 14, further comprises a clamping element receptacle for receiving a plurality of clamping elements, wherein each clamping element is arranged in a region of a welding point to be produced, and precisely one gas nozzle can be introduced temporally in succession into individual ones of the clamping elements.

16. The clamping device as claimed in claim 13, further comprising:
at least one additional clamping element to provide a plurality of clamping elements, the at least one additional clamping element comprising an additional housing; an additional pressure piece arranged so as to be movable relative to the additional housing; an additional spring, wherein the additional pressure piece is supported at least indirectly on the additional housing by means of the additional spring and an additional sleeve, wherein the additional spring is arranged in a radial direction between the additional housing and the additional sleeve, and a gas nozzle of the welding device can be introduced into the additional housing and into the additional sleeve; and
a clamping element receptacle for receiving the plurality of clamping elements, wherein each of the plurality of clamping elements is arranged in a region of a welding point to be produced, and precisely one gas nozzle can be introduced temporally in succession into individual ones of the plurality of clamping elements.

17. The clamping device as claimed in claim 16, wherein:
the pressure piece is annular;
the gas nozzle is at least partially introduced into the pressure piece; and
a welding wire is guided through the pressure piece.

18. The clamping device as claimed in claim 16, wherein:
the spring biases the pressure piece in a direction of a longitudinal axis; and
the pressure piece is displaceable relative to the housing along the longitudinal axis.

19. The clamping device as claimed in claim 18, wherein the pressure piece is tiltable with respect to the longitudinal axis.

20. The clamping device as claimed in claim 18, wherein the pressure piece has at least one hole for an outflow of gas.
